(19) United States
(12) Patent Application Publication
(10) Pub. No.: US 2016/0136910 A1
(43) Pub. Date: May 19, 2016

(54) SOLE ATTACHING METHOD AND APPARATUS

(71) Applicant: Dezi Krajcir, Dunnville (CA)

(72) Inventor: Dezi Krajcir, Dunnville (CA)

(21) Appl. No.: 14/547,288

(22) Filed: Nov. 19, 2014

(51) Int. Cl. B29D 35/10; A43B 13/12; B29D 35/00; A43B 13/04

(52) U.S. Cl. CPC B29D 35/10; A43B 13/04; A43B 13/12; B29D 35/0054

(57) ABSTRACT

The present concept is a method of attaching soles which minimizes delamination of the sole. It includes the steps of molding a sole together with a bond material by placing the bond material onto the sole material in the mold, and then adhering a bottom side of a bond material to the inside portion of the sole, in the mold by heating the mold to a pre-selected temperature and for a pre-selected amount of time. The bond material includes a hot melt polyurethane reactive film adhesive on a top side and a barrier material on the bottom side. Finally attaching the sole with bond material to an upper.

### FIELD OF THE INVENTION

The present concept relates to methods of bonding and attaching shoe or boot soles to a shoe and/or boot upper and more particularly relates to a sole attaching method and apparatus which minimizes delamination of the sole from the upper.

### BACKGROUND OF THE INVENTION

Currently, soles or outsoles are moulded by a rubber compounder which moulds the rubber sole or outsole. Once the rubber sole is moulded, the surface is washed with Ethyl Acetate to remove the oils from the sole in order to improve subsequent bonding to the upper. After a wait of approximately one hour, a urethane adhesive is applied to the sole. At this point, the sole and an upper are placed in a preheated mould and a polyether polyurethane material is injected between them.

A general shortcoming of the current method involves delamination. Within several months of the completion of the current process, the oils that are still present inside the rubber sole leach out to the bonding surface and cause delamination. This sole delamination results in returned or discarded footwear, which has a major financial impact on the companies producing the footwear. Additionally, the environmental and financial effect of discarded footwear collecting in landfills is incalculable.

Another shortcoming of the current method is the danger involved in the use of Ethyl Acetate. There are reports this compound is a health hazard, with acute effects including irritation of the skin, eyes, nose, and throat as well as dizziness and fainting occurring immediately or shortly after exposure. Long term chronic health effects may include decreased fertility in males as well as kidney and liver damage.

The present concept seeks to address these significant shortcomings by eliminating the use of Ethyl Acetate in the bonding process. It is an aim of this process to reduce the likelihood of delamination occurring so quickly after the attaching process, as well as eliminate a major health hazard for workers.

### SUMMARY OF INVENTION

The present concept includes a method for attaching soles to uppers comprising the steps of:

a) molding a sole together with a bond material by placing the bond material onto the sole material in the mold;
b) adhering a bottom side of a bond material to the inside portion of the sole, by heating the mold to a pre-selected temperature and for a pre-selected amount of time;
c) wherein the bond material includes a hot melt polyurethane reactive film adhesive on a top side and a barrier material on the bottom side;
d) attaching the sole with bond material to an upper.

Preferably wherein step b is replaced with step b′ as follows:

b′) vulcanizing a bottom side of a bond material to the inside portion of the sole, by placing the bond material onto the sole in the mold at a pre-selected temperature and for a pre-selected amount of time

Preferably wherein step b is replaced with step b′ as follows:

b′) compression vulcanizing a bottom side of a bond material to the inside portion of the sole, by placing the bond material onto the sole in the mold at a pre-selected temperature and pressure, for a pre-selected amount of time.

Preferably wherein step b is replaced with step b′ as follows:

b′) compression vulcanizing a bottom side of a bond material to the inside portion of the sole, by placing the bond material onto the sole in the mold at temperature between 200 to 400 F and at a preselected pressure, and for a pre-selected amount of time.

Preferably wherein step b is replaced with step b′ as follows:

b′) compression vulcanizing a bottom side of a bond material to the inside portion of the sole, by placing the bond material onto the sole in the mold at temperature between 200 to 400 F and at a preselected pressure, and for time of between 2 to 5 minutes.

Preferably wherein step b is replaced with step b′ as follows:

b′) compression vulcanizing a bottom side of a bond material to the inside portion of the sole, by placing the bond material onto the sole in the mold at a temperature of about 300 F for a time of between 3 to 4 minutes and a pressure of 2,000 to 3,000 psi.

Preferably further including the step bb after step b of;

bb): removing the excess cloth from around the periphery of the bonded sole by die cutting and placing the sole into a mold along with the upper.

Preferably further replacing step d with step dd as follows:

dd) directly attaching the sole with bond material to the upper by injection of an adhering material in between the upper and the bond material creating a midsole, wherein the polyurethane reactive film adhesive bonds to the midsole producing a strong midsole bond between the sole and the upper.

Preferably wherein the sole material is rubber.

Preferably wherein the bond material includes a hot melt polyurethane reactive film on the top side and a brushed polyester on the bottom side being the barrier material.

Preferably wherein the adhering material selected from among polyether polyurethane and polyester polyurethane.

Preferably wherein the barrier material being a woven cloth like material.

Preferably wherein the barrier material selected from among polyester, brushed polyesters, nylon, brushed nylon, polypropylene, brushed polypropylene, polyurethane.

The present concept includes a method for attaching midsoles to a sole comprising the steps of:
a) molding a midsole together with a bond material by placing the bond material onto the midsole material in the mold;
b) adhering a bottom side of a bond material to the midsole, in the mold by heating the mold to a pre-selected temperature and for a pre-selected amount of time;
c) wherein the bond material includes a hot melt polyurethane reactive film on a top side and a barrier material on the bottom side;
d) attaching the midsole sole with bond material to a sole.

Preferably wherein step b is replaced with step b′ as follows:

b′) vulcanizing a bottom side of a bond material to the midsole, by placing the bond material onto the midsole in the mold at a pre-selected temperature and for a pre-selected amount of time.

Preferably wherein step b is replaced with step b′ as follows:
b′) compression vulcanizing a bottom side of a bond material to the midsole, by placing the bond material onto the midsole in the mold at a pre-selected temperature and pressure, and for a pre-selected amount of time.

Preferably wherein step b is replaced with step b′ as follows:

b′) compression vulcanizing a bottom side of a bond material to the midsole, by placing the bond material onto the midsole in the mold at temperature between 200 to 400 F and at a preselected pressure, and for a pre-selected amount of time.

Preferably wherein step b is replaced with step b′ as follows:

b′) compression vulcanizing a bottom side of a bond material to the midsole, by placing the bond material onto the midsole in the mold at temperature between 200 to 400 F and at a preselected pressure, and for time of between 2 to 5 minutes.

Preferably wherein step b is replaced with step b′ as follows:

b′) compression vulcanizing a bottom side of a bond material to the mid sole, by placing the bond material onto the midsole in the mold at a temperature of about 300 F for a time of between 3 to 4 minutes and a pressure of 2,000 to 3,000 psi.

Preferably further including the step bb after step b of;

bb): removing the excess cloth from around the periphery of the bonded midsole by die cutting and placing the midsole into a mold along with the upper.

Preferably further replacing step d with step dd as follows:

dd) directly attaching the midsole with bond material to the sole by injection of an adhering material in between the sole and the bond material, wherein the polyurethane reactive film adhesive bonds to the midsole bond material producing a strong midsole bond between the sole and the upper.

### BRIEF DESCRIPTION OF THE DRAWINGS

The present concept will now be described by way of example only with reference to the following drawings in which:

FIG. 1 is a top plan view of the bond material showing the polyurethane film top side.

FIG. 2 is a bottom plan view of the bond material showing the bottom side brushed polyester material.

FIG. 3 is a side cross sectional view of the bond material showing the two layers namely the top layer of a polyurethane film and a bottom layer of the brushed polyester.

FIG. 4 is a schematic cross sectional view of the bind material being attached to the sole.

FIG. 5 is a schematic side cross sectional view of the bond material after it has been bonded to the sole, thereby creating a bonded sole.

FIG. 6 is a schematic partial cross sectional view of a lasted upper bonded to the bonded sole with an injected polyester polyurethane mid sole.

FIG. 7 is a bottom plan view of the sole bottom.

FIG. 8 is an exploded assembly view of the sole attaching layers namely a lasted upper bonded to an injected mid sole which in turn is bonded to the bond material which in turn in bonded to the sole.

FIG. 9 is schematic flow diagram of the present method namely a sole attaching method and apparatus.

FIG. 10 is a schematic flow diagram of the prior art method of attaching soles.

### DESCRIPTION OF THE PREFERRED EMBODIMENTS

### Definitions

Sole: part of an item of footwear upon which the wearer treads. Also sometimes referred to as outsole.
Upper: the upper part of the shoe or boot that helps hold the shoe or boot onto the foot. It is attached to the sole of the shoe or boot.
Lasted Upper: Uppers are molded into a shape of a foot with the help of a “Last”

Referring first of all to FIG. 10 which shows the prior art method of attaching soles to lasted uppers the current method of carrying out this process is as follows:

Firstly the sole also referred to in the art as the outer skin and also referred to in the art as an outsole is moulded by a rubber compounder which moulds the rubber sole at a pre-selected temperature normally somewhere around 300° F.

In order to remove the oils naturally found within the compounds used to mold the sole the next step in the prior art process is to wash the surface of the sole with a wash called Satrerate® which is a form of ethyl acetate. The ethyl acetate wash removes any naturally occurring oils and other oily substances from the top sole which prevent proper lamination and adhesion of the sole to the mid sole and eventually to the lasted upper.

This ethyl acetate wash cleans oils from the sole and improves bonding in subsequent bonding processes.

The prior art process then will wait roughly one hour and thereafter apply urethane adhesive to the sole and place the sole into a preheated mold together with the lasted upper which may be a lasted leather upper and inject into the mould a polyether polyurethane and/or a polyester polyurethane material between the moulded sole and the lasted leather upper boot in order to bond the sole to the lasted leather upper boot. This injected polyether and/or polyester polyurethane is often referred to as the mid sole in the completed boot and is sometimes visible between the bottom sole and the lasted leather upper.

The problem with the use of ethyl acetate in order to improve the bonding between the bottom sole and the lasted leather upper is that over time and often as short as six months later the oils that are still present in the sole leach through to the sole top 124 of the bonding surface and/or cause delamination of the sole from the mid sole and ultimately from the lasted leather upper. Delamination of soles results in returned footwear and warranty claims which create losses to companies manufacturing the shoes and the boots.

Additionally the ethyl acetate is a dangerous chemical which is known to be a carcinogen and requires special facilities and protective gear when using the ethyl acetate wash.

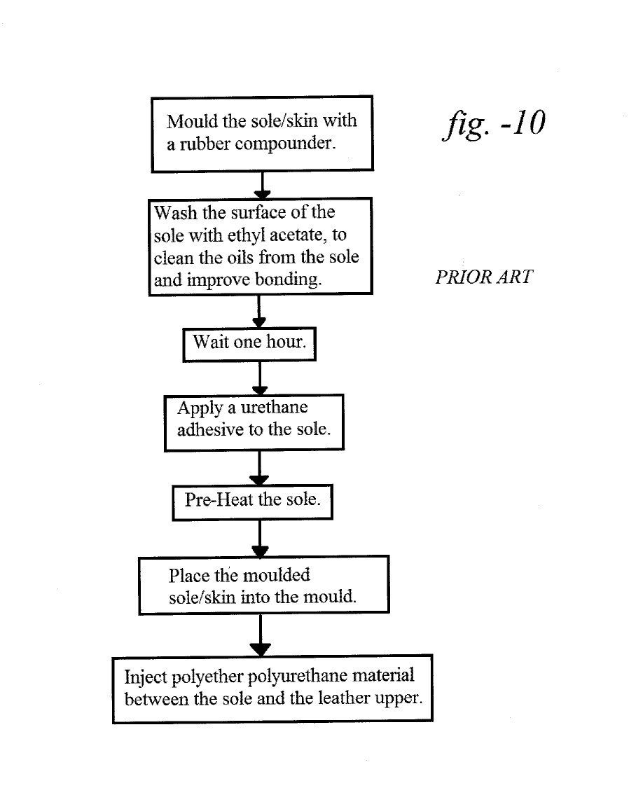

The presently developed sole attaching method and apparatus is summarized in FIG. 9 in flow chart format and includes the following steps.

First, one would prepare a bond material which is made up of a hot melt polyurethane reactive film adhesive which is coated on one side and with a barrier material such as brushed polyester cloth on the other side shown as 204 in FIG. 9.

Then, the sole is moulded together with a bond material by placing the bond material onto the sole material in the mould, shown in FIG. 9 as 202.

One would then adhere the bottom side of the bond material to the inside portion of the sole by heating the mould to a pre-selected temperature preferably between 200° F. and 400° F. and for a pre-selected amount of time, preferably 2 to 5 minutes. This creates a bonded sole as shown as 206 in FIG. 9.

One would then die cut the excess bonded material from around the periphery of the bonded sole/skin, shown as 208 in FIG. 9.

One would then place the bonded sole/skin into the mould together with the lasted upper boot and inject polyether or polyester polyurethane 146 between the bonded sole/skin and the lasted upper 140 to directly attach the bonded sole/skin to the leather upper with the injected polyurethane mid sole material which is shown as 210 in FIG. 9.

Lastly the hot melt polyurethane reactive film adhesively bonds to the injected polyether or polyester polyurethane producing a strong midsole bond which attaches to the bonded sole/skin and also the leather upper shown as 212 in FIG. 9.

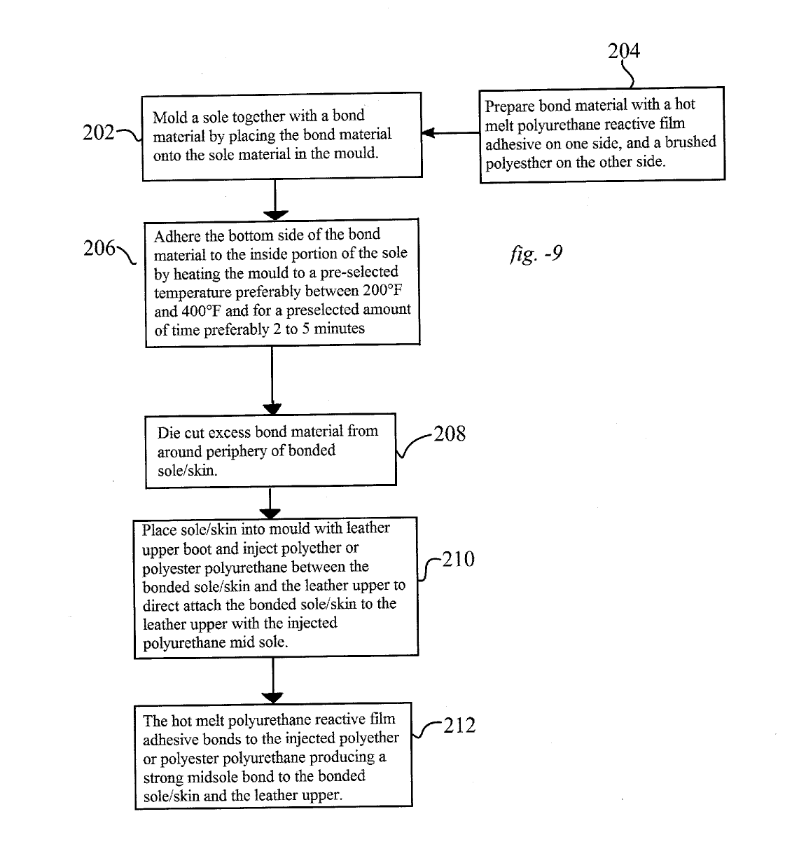

Referring now to FIGS. 1 through 7 the materials and layers used to carry out the sole attaching method and apparatus are depicted.

FIG. 1 shows the top side 104 of bond material 102 which is a polyurethane film 106.

FIG. 2 shows the bottom side 110 of bond material 102 which is a barrier material such as brushed polyester material 108.

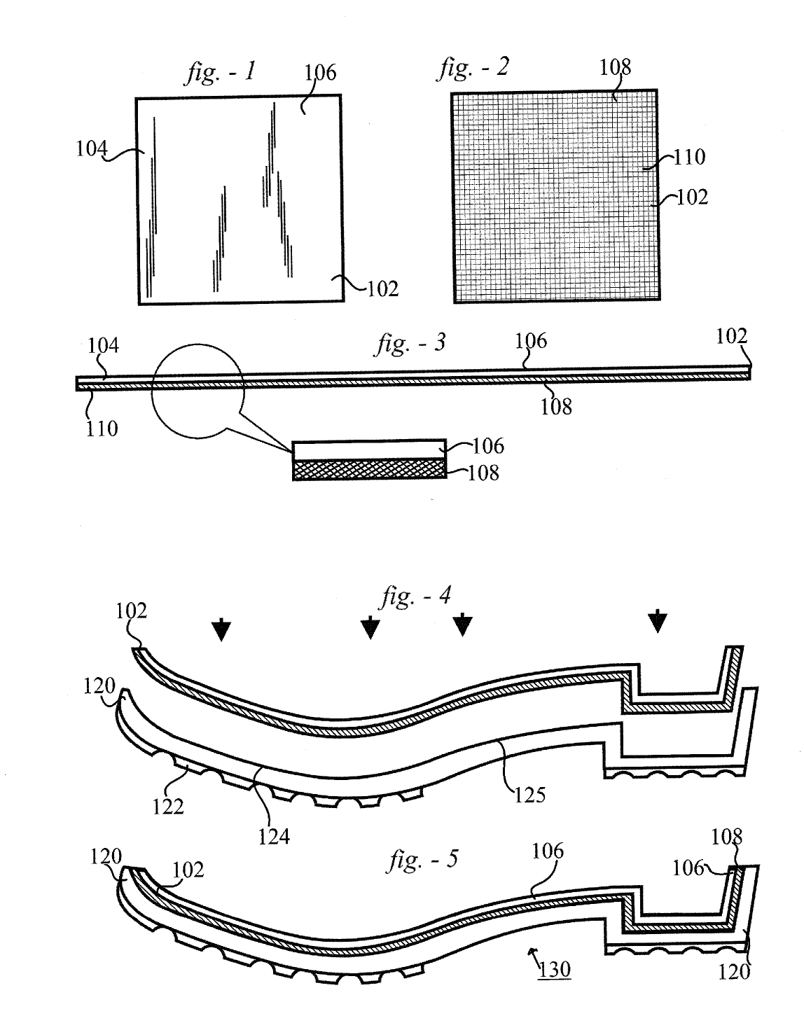

FIG. 3 is a schematic cross sectional view of the bond material showing the top side 104 being a polyurethane film 106 and the bottom side 110 being a brushed polyester cloth 108.

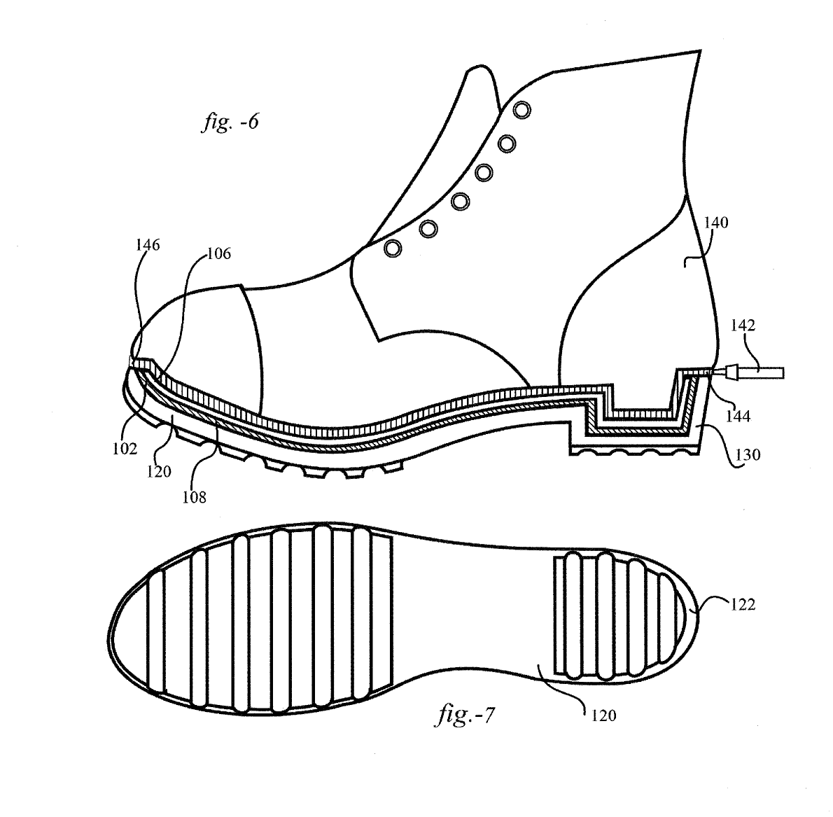

FIG. 4 is a schematic cross sectional assembly view of a sole 120 showing a sole bottom 122 and sole top 124 and also the inside portion of the sole 125. The bond material 102 is placed in the mould together with sole 120 and forceably moulded into the inside portion 125 of sole top 124 at temperature in order to bond/vulcanize bond material 102 to sole 120.

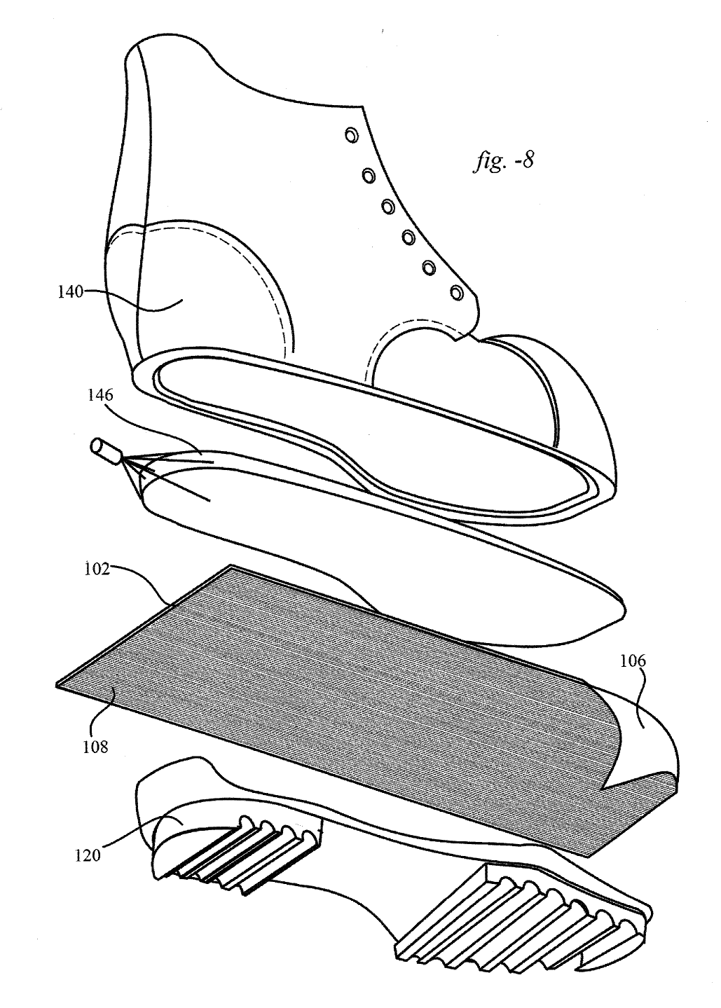

FIG. 5 is a schematic cross sectional view of a bonded sole shown as 130 which includes the following layers from top to bottom namely polyurethane film 106 at the top then a brushed polyester cloth 108 shown in the middle and then the sole 120 which is preferably made of a rubber material in the bottom.

FIG. 6 is a schematic representation of a lasted upper 140 shown together with the bonded sole 130 which would be placed in a mould together with an injector 142 which would be used to inject a polyester polyurethane 144 or a polyether polyurethane in between the bonded sole 130 and the lasted upper 140 thereby creating a midsole 146.

The polyester poly urethane midsole 146 securely bonds together the lasted upper 140 to the bonded sole 130.

The layers in the finished product are as follows: at the bottom the sole 120 which is attached to the brushed polyester 108 which in turn is attached to the polyurethane reactive hot melt film 106 which in turn is adhesively attached to the polyester polyurethane midsole 146 which in turn is attached to the lasted upper 140.

FIG. 8 shows in exploded fashion the various layers used in the sole attaching method and apparatus namely the sole 120 which is attached to the bond material 102 which has a bottom portion of brushed polyester 108 and a top portion of poly urethane reactive hot melt film 106 which in turn is bonded to and injected midsole 146 which normally is comprised of either polyether or polyester polyurethane and the lasted upper 140.

The use of the bond material 102 eliminates the need for ethyl acetate wash since the brushed polyester 108 very easily bonds to the inside portion 125 of sole 120 during the bonding process and acts as barrier material to prevent the natural oils and other contaminants from leaching from the sole 120 up to the midsole 146 thereby causing the bonding to delaminate over time.

In other words bond material 102 acts as a barrier to prevent the leaching and migration of natural oils from sole 120 up to the midsole 146 thereby preventing delamination of the sole of a lasted upper 140.

The bond material can used in situations where rubber must be boned to another material thereby eliminating the Ethyl Acetate wash.

It should be apparent to persons skilled in the arts that various modifications and adaptation of this structure described above are possible without departure from the spirit of the invention the scope of which defined in the appended claim.

1. A method for attaching soles to uppers comprising the steps of:
a) molding a sole together with a bond material by placing the bond material onto the sole material in the mold;
b) adhering a bottom side of a bond material to the inside portion of the sole, by heating the mold to a pre-selected temperature and for a pre-selected amount of time;
c) wherein the bond material includes a hot melt polyurethane reactive film adhesive on a top side and a barrier material on the bottom side;
d) attaching the sole with bond material to an upper.

2. The method claimed in claim 1 wherein step b is replaced with step b′ as follows:
b′) vulcanizing a bottom side of a bond material to the inside portion of the sole, by placing the bond material onto the sole in the mold at a pre-selected temperature and for a pre-selected amount of time

3. The method claimed in claim 1 wherein step b is replaced with step b′ as follows:
b′) compression vulcanizing a bottom side of a bond material to the inside portion of the sole, by placing the bond material onto the sole in the mold at a pre-selected temperature and pressure, for a pre-selected amount of time

4. The method claimed in claim 3 wherein step b is replaced with step b′ as follows:
b′) compression vulcanizing a bottom side of a bond material to the inside portion of the sole, by placing the bond material onto the sole in the mold at temperature between 200 to 400 F and at a preselected pressure, and for a pre-selected amount of time

5. The method claimed in claim 3 wherein step b is replaced with step b′ as follows:
b′) compression vulcanizing a bottom side of a bond material to the inside portion of the sole, by placing the bond material onto the sole in the mold at temperature between 200 to 400 F and at a preselected pressure, and for time of between 2 to 5 minutes.

6. The method claimed in claim 3 wherein step b is replaced with step b′ as follows:
b′) compression vulcanizing a bottom side of a bond material to the inside portion of the sole, by placing the bond material onto the sole in the mold at a temperature of about 300 F for a time of between 3 to 4 minutes and a pressure of 2,000 to 3,000 psi.

7. The method claimed in claim 3 further including the step bb after step b of;
bb): removing the excess cloth from around the periphery of the bonded sole by die cutting and placing the sole into a mold along with the upper.

8. The method claimed in claim 1 further replacing step d with step dd as follows:
dd) directly attaching the sole with bond material to the upper by injection of an adhering material in between the upper and the bond material creating a midsole, wherein the polyurethane reactive film adhesive bonds to the midsole producing a strong midsole bond between the sole and the upper.

9. The method claimed in claim 1 wherein the sole material is rubber.

10. The method claimed in claim 1 wherein the bond material includes a hot melt polyurethane reactive film on the top side and a brushed polyester on the bottom side being the barrier material.

11. The method claimed in claim 8 wherein the adhering material selected from among polyether polyurethane and polyester polyurethane.

12. The method claimed in claim 1 wherein the barrier material being a woven cloth like material.

13. The method claimed in claim 12 wherein the barrier material selected from among polyester, brushed polyesters, nylon, brushed nylon, polypropylene, brushed polypropylene, polyurethane.

14. A method for attaching midsoles to a sole comprising the steps of:
a) molding a midsole together with a bond material by placing the bond material onto the midsole material in the mold;
b) adhering a bottom side of a bond material to the midsole, in the mold by heating the mold to a pre-selected temperature and for a pre-selected amount of time;
c) wherein the bond material includes a hot melt polyurethane reactive film on a top side and a barrier material on the bottom side;
d) attaching the midsole sole with bond material to a sole.

15. The method claimed in claim 14 wherein step b is replaced with step b′ as follows:
b′) vulcanizing a bottom side of a bond material to the midsole, by placing the bond material onto the midsole in the mold at a pre-selected temperature and for a pre-selected amount of time.

16. The method claimed in claim 14 wherein step b is replaced with step b′ as follows:
b′) compression vulcanizing a bottom side of a bond material to the midsole, by placing the bond material onto the midsole in the mold at a pre-selected temperature and pressure, and for a pre-selected amount of time

17. The method claimed in claim 16 wherein step b is replaced with step b′ as follows:
b′) compression vulcanizing a bottom side of a bond material to the midsole, by placing the bond material onto the midsole in the mold at temperature between 200 to 400 F and at a preselected pressure, and for a pre-selected amount of time

18. The method claimed in claim 16 wherein step b is replaced with step b′ as follows:
b′) compression vulcanizing a bottom side of a bond material to the midsole, by placing the bond material onto the midsole in the mold at temperature between 200 to 400 F and at a preselected pressure, and for time of between 2 to 5 minutes.

19. The method claimed in claim 16 wherein step b is replaced with step b′ as follows:
b′) compression vulcanizing a bottom side of a bond material to the mid sole, by placing the bond material onto the midsole in the mold at a temperature of about 300 F for a time of between 3 to 4 minutes and a pressure of 2,000 to 3,000 psi.

20. The method claimed in claim 16 further including the step bb after step b of;
bb): removing the excess cloth from around the periphery of the bonded midsole by die cutting and placing the midsole into a mold along with the upper.

21. The method claimed in claim 14 further replacing step d with step dd as follows:
dd) directly attaching the midsole with bond material to the sole by injection of an adhering material in between the sole and the bond material, wherein the polyurethane reactive film adhesive bonds to the midsole bond material producing a strong midsole bond between the sole and the upper.
